(19) United States
(12) Patent Application Publication
(10) Pub. No.: US 2001/0031834 A1
(43) Pub. Date: Oct. 18, 2001

(54) Polypropylene composition

(75) Inventors: Tsutomu Ushioda, Chiba (JP); Tsuyoshi Yahata, Chiba (JP)

Correspondence Address: McDERMOTT, WILL & EMERY, 600 13th Street, N.W., Washington, DC, 20005-3096, US

(73) Assignee: Chisso Corporation

(21) Appl. No.: 09/795,310

(22) Filed: Mar. 1, 2001

(30) Foreign Application Priority Data
Mar. 17, 2000 (JP) 2000-076238
Jan. 15, 2001 (JP) 2001-006155

(51) Int. Cl. C08L 23/12

(52) U.S. Cl. 525/240

(57) ABSTRACT

Provided is a polypropylene composition which is a molding material having good flexibility and good elastic recovery.

The polypropylene composition comprises from 1 to 99% by weight of elastomeric polypropylene obtained through (co)polymerization of propylene or propylene and olefin except propylene in the presence of a metallocene catalyst (A) that comprises a metallocene compound (A), an activator compound and optionally an organoaluminum compound, or of a supported metallocene catalyst (A) that comprises the metallocene catalyst (A) supported on a particulate carrier, or of a catalyst that comprises tetraneophyl zirconium supported on alumina, and from 1 to 99% by weight of atactic polypropylene totaling 100% by weight.

### BACKGROUND OF THE INVENTION

1. Field of the Invention

The present invention relates to a polypropylene composition having the advantages of good flexibility and good elastic recovery.

More precisely, the invention relates to a polypropylene composition having the advantages of good flexibility and good elastic recovery, which comprises elastomeric polypropylene and atactic polypropylene in a specific ratio.

2. Description of the Related Art

Crystalline, amorphous and elastic polypropylenes are known. In general, it is believed that the majority of crystalline polypropylene has an isotactic or syndiotactic structure, and that the majority of amorphous polypropylene has an atactic structure. In U.S. Pat. Nos. 3,112,300 and 3,112,301, described are isotactic polypropylene and polypropylene predominantly having an isotactic structure.

In U.S. Pat. No. 3,175,199, described is elastic polypropylene capable of being fractionated from a polymer mixture that contains, as the essential ingredients, isotactic polypropylene and atactic polypropylene. They say that one fraction obtained through fractionation of the polymer mixture exhibits elastic characteristics caused by its stereoblock structure of alternate isotactic blocks and atactic blocks.

It has heretofore been known to use heterogeneous catalysts such as those containing a titanium or vanadium halide supported on carrier (German Patent DD 300,293) or those containing a tetraalkyl zirconium or titanium supported on a metal oxide carrier (U.S. Pat. No. 4,335,225), in producing so-called stereoblock amorphous/crystalline polypropylene having a stereoblock structure of alternate isotactic blocks and atactic blocks.

These heterogeneous catalysts have a plurality of non-uniform catalytic active sites and not a single catalytic active site. In the presence of the catalyst of that type, therefore, produced is a polymer mixture capable of being fractionated into fractions in extraction fractionation with a suitable solvent. Various types of fractions thus fractionated from the polymer mixture differ from each other typically in the molecular weight and in the molecular weight distribution, and also in the physical properties.

On the other hand, metallocene catalysts are effective for polymerizing α-olefins selectively into atactic, isotactic or syndiotactic polymers. In particular, as so disclosed by Ewen et al. in J. Am. Chem. So., 106, 6355-6364 (1984), isotactic polypropylene is produced in the presence of a racemi-structured bridged metallocene catalyst, and atactic polypropylene is produced in the presence of a meso-structured bridged metallocene catalyst.

Also known are metallocene catalysts capable of giving elastomeric polypropylene. (Chien, Linas et al's J. Am. Chem. Soc., 113, 8569-8570 (1991); Cheng, Babu et al's Macromolecules, 25, 6980-6987 (1992); Linas, Dong et al's Macromolecules, 25, 1242-1253 (1992)).

However, the catalysts disclosed in these references have low polymerization activity (3.5×10⁵ g-polymer/mol-Ti) and give only polypropylene having a molecular weight of smaller than 200,000, but for its composition, the polypropylene is more homogeneous and completely dissolves in diethyl ether. They say that the polypropylene has a melting point of lower than 70° C., its elongation is at most 1300% and its tensile strength is 12.1 MPa.

Accordingly, desired is a catalyst having a higher activity and capable of controlling the structure of the polymer to be produced in a reaction process of propylene polymerization in the presence of it, and therefore capable of giving a high-molecular-weight polymer having a narrow molecular weight distribution of which the atactic blocks and the isotactic blocks to form its steric configuration are in a specifically selected ratio and which have predetermined characteristics including thermoplastic elastic characteristics.

Waymouth et al. have proposed a novel metallocene catalyst and a catalyst system containing it, which are for producing a stereoblock polypropylene having a stereoblock structure of alternate isotactic blocks and atactic blocks and therefore having wide-range elastic characteristics, in International Patent Publication No. 510745/1997. The catalyst proposed therein is a non-bridged metallocene catalyst essentially containing a substituted indenyl group as the ligand, and this can control the structure of the produced polyolefin at a time scale lower than the olefin insertion rate but higher than the average time for forming the single polymer chain (through polymerization) to thereby make the produced polyolefin have the intended stereoblock structure.

The structural symmetry of the metallocene catalyst alternately varies to have a chiral or achiral structure through isomerization. The structural change in the catalyst can be controlled by selecting the type and the structure of the ligand to be therein or by controlling the polymerization condition for it. With that, the physical properties of the polymer to be produced in the presence of the catalyst can be controlled accurately. The thermoplastic elastic polypropylene obtained in the presence of the catalyst has an elongation at break of from 20% to 5000%, typically from 100% to 3000%, and has a residual elongation (elongation set) of from 5 to 300%, typically from 100 to 200%, but preferably from 10 to 70%. The tensile strength of the polypropylene falls between 0.7 MPa and 41 MPa, typically between 2.8 MPa and 34 MPa. Regarding its crystallinity, the polymer covers from an amorphous polymer not showing a melting point to a crystalline thermoplastic polymer having a melting point of about 165° C. They say that the polymer preferably has a melting point falling between 50° C. and 165° C.

These stereoblock polypropylenes by the prior art techniques are generally referred to as elastomeric polypropylenes, and they have good elastic recovery. However, their elastic recovery is generally on the same level as that of soft polyvinyl chloride. Therefore, further improving the elastic recovery of the polymers is desired. The elastomeric polypropylenes have a durometer hardness, HDA of typically from 70 to 80 or so, measured with a type A durometer according to JIS K7215. Therefore, more flexible polymers are desired.

### SUMMARY OF THE INVENTION

We, the present inventors have assiduously studied so as to obtain a polypropylene composition having more improved elastic recovery and flexibility. As a result, we have found that a polypropylene composition comprising elastomeric polypropylene obtained through (co)polymerization of propylene or propylene and olefin except propylene in the presence of a specific metallocene catalyst (A), or a supported metallocene catalyst (A) that comprises the metallocene catalyst (A) supported on a particulate carrier, or a catalyst that comprises tetraneophyl zirconium supported on alumina, and atactic polypropylene in a specific ratio can attain the intended object. On the basis of this finding, we have completed the present invention. As is obvious from the above description, the object of the invention is to provide a polypropylene composition having more improved elastic recovery and flexibility.

The invention includes the following:

(1) A polypropylene composition comprising from 1 to 99% by weight of elastomeric polypropylene obtained through (co) polymerization of propylene or propylene and olefin except propylene in the presence of a metallocene catalyst (A) that comprises a metallocene compound (A), an activator compound and optionally an organoaluminium compound, or of a supported metallocene catalyst (A) that comprises the metallocene catalyst (A) supported on a particulate carrier, or of a catalyst that comprises tetraneophyl zirconium supported on alumina, and from 1 to 99% by weight of atactic polypropylene totaling 100% by weight.

(2) The polypropylene composition of above 1, wherein the atactic polypropylene is obtained through (co) polymerization of propylene or propylene and olefin except propylene in the presence of a metallocene catalyst (B) that comprises a metallocene compound (B), an activator compound and optionally an organoaluminium compound, or of a supported metallocene catalyst (B) that comprises the metallocene catalyst (B) supported on a particulate carrier.

(3) The polypropylene composition of above 1, which has a durometer hardness, HDA of from 40 to 60, measured with a type A durometer according to JIS K7215.

### DESCRIPTION OF THE PREFERRED EMBODIMENTS

The polypropylene composition of the invention comprises from 1 to 99% by weight of elastomeric polypropylene and from 1 to 99% by weight of atactic polypropylene totaling 100% by weight. Preferably, elastomeric polypropylene accounts for from 20 to 80% by weight of the composition, and atactic polypropylene for from 80 to 20% by weight; and more preferably, elastomeric polypropylene accounts for from 30 to 70% by weight of the composition, and atactic polypropylene for from 70 to 30% by weight.

The polypropylene composition of the invention is highly flexible, and its durometer hardness HDA preferably falls between 40 and 60, measured with a type A durometer according to JIS K7215.

The intrinsic viscosity [η] of elastomeric polypropylene for use in the invention preferably falls between 0.5 and 10 dl/g, more preferably between 1 and 4 dl/g, and is preferably nearly on the same level as that of the intrinsic viscosity of industrial polypropylene widely used in the art.

The elastomeric polypropylene for use in the invention is a propylene homopolymer or a copolymer of propylene with α-olefin such as ethylene, 1-butene, 1-hexene, 1-octene or the like, which is obtained through (co)polymerization of propylene or propylene and olefin except propylene, in the presence of a specific catalyst, and of which the propylene/α-olefin copolymer has an olefin content of at most 50% by weight.

The terminology “(co) polymerization” referred to herein is meant to indicate homopolymerization or copolymerization.

In producing the elastomeric polypropylene, used is any of specific catalyst systems mentioned below.

Precisely, one type of the specific catalyst systems is a metallocene catalyst system (A) including a metallocene catalyst (A) that comprises a metallocene compound (A) mentioned below, an activator compound and optionally an organoaluminium compound, and a supported metallocene catalyst (A) that comprises the metallocene catalyst (A) supported on a particulate carrier.

Specific examples of the metallocene compound (A) are metallocene compounds of the following general formula (1):

L₂MX₂ (1).

In formula (1), M is selected from titanium, zirconium and hafnium; X is selected from halogens, alkoxides and hydrocarbon groups having from 1 to 7 carbon atoms, and two X's may be the same or different; L is selected from the groups of the following general formula (2) or (3) in any desired manner, and two L's may be the same or different.

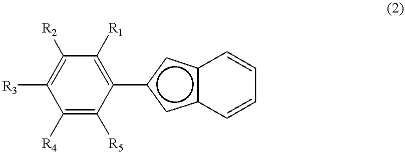

In formula (2), R₁, R₂, R₃, R₄ and R₅ each are selected from hydrogen, halogens, aryls, hydrocarbons, silane-containing hydrocarbons, and halogen-containing hydrocarbons.

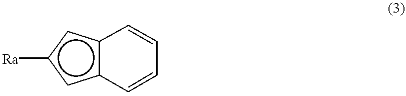

In formula (3) Ra represents a monocyclic or polycyclic hetero-aromatic group that contains hetero atom(s) selected from oxygen, sulfur and nitrogen atoms. For example, the oxygen atom-containing monocyclic or polycyclic aromatic group includes a furyl group and a benzofuryl group; and the furyl group includes a 2-furyl group, a 3-furyl group, etc. The sulfur atom-containing monocyclic or polycyclic aromatic group includes, for example, a thienyl group and a benzothienyl group; and the thienyl group includes a 2-thienyl group, a 3-thienyl group, etc.

The nitrogen atom-containing monocyclic or polycyclic aromatic group includes, for example, a pyrrolyl group, a pyridyl group, an indolyl group and a quinolyl group. The pyrrolyl group includes a 1-pyrrolyl group, a 2-pyrrolyl group and 3-pyrrolyl group; the pyridyl group includes a 2-pyridyl group, a 3-pyridyl group and 4-pyridyl group; the indolyl group includes a 1-indolyl group and a 3-indolyl group; and the quinolyl group includes 1-quinolyl group and 3-quinolyl group. In the hetero-aromatic group Ra, the atoms constituting the aromatic ring may be substituted with any of alkyl groups, aryl groups, aralkyl groups, alkoxy groups and substituted silyl groups; the neighboring substituents may be bonded to each other to form a cyclic structure. Specific examples of the substituents are a methyl group, an ethyl group, a t-butyl group, a phenyl group, a vinyl group, a methoxy group, a trimethylsilyl group, a vinyldimethylsilyl group, a phenyldimethylsilyl group, a methoxydimethylsilyl group, etc.

Of the hetero-aromatic groups, preferred are a 2-furyl group, a 3-furyl group, a 2-thienyl group, a 3-thienyl group, a 2-pyrrolyl group, a 3-pyrrolyl group, a 2-pyridyl group, a 3-pyridyl group, a 4-pyridyl group, a benzofuryl group, a benzothienyl group, a 3-indolyl group, a 1-quinolyl group, and a 3-quinolyl group; more preferred are a furyl group; and even more preferred is a 2-furyl group. The 2-furyl group includes 2-furyl, 2-benzofuryl, 2-(5-methyl) furyl, 2-(5-t-butyl) furyl, 2-(5-trimethylsilyl)furyl, 2-(5-vinyldimethylsilyl)furyl, 2-(4,5-benzofuryl), 2-(4,5-dimethyl)furyl groups.

Specific but non-limitative examples of the metallocene compound (A) of formula (1) are bis[2-phenylindenyl]zirconium dichloride, bis[2-phenylindenyl]zirconium-dimethyl, bis[2-(3,5-dimethylphenyl)indenyl]zirconium dichloride, bis[2-(3,5-bis-trifluoromethylphenyl)indenyl]zirconium dichloride, bis[2-(4-fluorophenyl)indenyl]zirconium dichloride, bis [2-(2,3,4,5-tetrafluorophenyl)indenyl]zirconium dichloride, bis[2-(1-naphthyl)indenyl]zirconium dichloride, bis[2-(2-naphthyl)indenyl]zirconium dichloride, bis[2-(4-phenyl)phenylindenyl]zirconium dichloride, bis[2-(3-phenyl)phenylindenyl]zirconium dichloride, bis[2-phenylindenyl]hafnium dichloride, bis[2-phenylindenyl]hafnium-dimethyl, bis[2-(3,5-dimethylphenyl)indenyl]hafnium dichloride, bis[2-(3,5-bis-trifluoromethylphenyl)indenyl]hafnium dichloride, bis[2-(4-fluorophenyl)indenyl]hafnium dichloride, bis[2-(2,3,4,5-tetrafluorophenyl)indenyl]hafnium dichloride, bis[2-(1-naphthyl)indenyl]hafnium dichloride, bis[2-(2-naphthyl)indenyl]hafnium dichloride, bis[2-[(4-phenyl)phenyl]indenyl]hafnium dichloride, bis[2-[(3-phenyl)phenyl]indenyl]hafnium dichloride, bis(2-(2-furyl)indenyl)zirconium dichloride, bis(2-(2-furyl)indenyl)zirconium dibromide, bis(2-(2-furyl)indenyl)zirconium-methyl chloride, bis(2-(2-furyl)indenyl)zirconium-dimethyl, bis(2-(2-furyl)indenyl)zirconium-diphenyl, bis(2-(2-thienyl)indenyl)zirconium dichloride, bis(2-(N-pyrrolyl)indenyl)zirconium dichloride, bis(2-(2-pyridyl)indenyl)zirconium dichloride, bis(2-(2-benzofuryl)indenyl)zirconium dichloride, bis(2-(2-indolyl) indenyl) zirconium dichloride, bis (2-(2-quinolyl) indenyl) zirconium dichloride, bis (2-(2-furyl)-1-methylindenyl)zirconium dichloride, bis(2-(2-furyl)-4-methylindenyl )zirconium dichloride, bis(2-(2-furyl)-4-phenylindenyl)zirconium dichloride, bis(2-(2-furyl)-4-naphthylindenyl)zirconium dichloride, bis(2-(2-furyl)-4,5-benzoindenyl)zirconium dichloride, bis(2-(2-(5-trimethylsilyl)furyl)indenyl)zirconium dichloride, bis (2-(2-(5-vinyldimethylsilyl)furyl)indenyl)zirconium dichloride, bis(2-(2-(5-phenyl)furyl)indenyl)zirconium dichloride, bis(2-(2-(5-methyl)furyl)indenyl)zirconium dichloride, bis(2-(2-(4,5-dimethyl)furyl)indenyl)zirconium dichloride, bis(2-(2-furyl)indenyl)hafnium dichloride, bis(2-(2-furyl)indenyl)hafnium dibromide, bis(2-(2-furyl)indenyl)hafnium-methyl chloride, bis(2-(2-furyl)indenyl)hafnium-dimethyl, bis(2-(2-furyl)indenyl)hafnium-diphenyl, bis(2-(2-thienyl)indenyl)hafnium dichloride, bis(2-(2-pyrrolyl))indenyl)hafnium dichloride, bis(2-(2-pyridyl)indenyl)hafnium dichloride, bis(2-(2-benzofuryl)indenyl)hafnium dichloride, bis(2-(2-indolyl)indenyl)hafnium dichloride, bis(2-(2-quinolyl)indenyl)hafnium dichloride, bis(2-(2-furyl)indenyl)titanium dichloride, bis(2-(2-furyl) indenyl)titanium dibromide, bis(2-(2-furyl)indenyl)titanium-methyl chloride, bis(2-(2-furyl)indenyl)titanium-dimethyl, bis(2-(2-furyl) indenyl) titanium-diphenyl, bis (2-(2-thienyl) indenyl) titanium dichloride, bis (2-(2-pyrrolyl) )indenyl)titanium dichloride, bis (2-(2-pyridyl)indenyl)titanium dichloride, bis(2-(2-benzofuryl) indenyl)titanium dichloride, bis(2-(2-indolyl)indenyl)titanium dichloride, bis(2-(2-quinolyl)indenyl)titanium dichloride, etc.

In addition to the examples mentioned above, other known metallocene compounds such as those described in International Patent Publication No. 510745/1997; WO98/57996; Organometallics, 18, 380-388 (1999); J. Am. Chem. Soc., 120, 2039046 (1998); J. Mol. Cat. A: Chemical, 136, 23-33 (1998); Organometallics, 16, 5909-5916; Macromolecules, 31, 1000-1009 (1998); Macromolecules, 28, 3771-3778 (1885); Macromolecules, 28, 3779-3786 (1995); Macromolecules, 25, 1242-1253 (1992), etc. may also be used herein for the metallocene compound (A).

The activator compound for use herein includes organoaluminium-oxy compounds, and compounds capable of reacting with the above-mentioned metallocene compound (A) to form ion pairs.

The organoaluminium-oxy compounds include aluminoxanes of the following general formula (4) or (5):

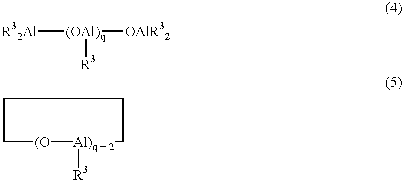

In these formulae, R³ represents a hydrocarbon group having from 1 to 6, preferably from 1 to 4 carbon atoms. Concretely, it includes an alkyl group such as a methyl group, an ethyl group, a propyl group, a butyl group, an isobutyl group,

a pentyl group, a hexyl group, etc.; an alkenyl group such as an allyl group, a 2-methylallyl group, a propenyl group, an isopropenyl group, a 2-methyl-1-propenyl group, a butenyl group, etc.; a cycloalkyl group such as a cyclopropyl group, a cyclobutyl group, a cyclopentyl group, a cyclohexyl group, etc.; an aryl group, etc. Of those, preferred is an alkyl group. Plural R³'s may be the same or different. q represents an integer of from 4 to 30, and is preferably from 6 to 30, more preferably from 8 to 30.

The aluminoxanes mentioned above may be prepared in various known conditions. Concretely, some methods for preparing them are mentioned below.

<1> A method of directly reacting a trialkylaluminium with water in an organic solvent such as toluene, ether, etc. [0041]

<2> A method of reacting a trialkylaluminium with a salt containing crystal water, such as copper sulfate hydrate, aluminium sulfate hydrate, etc.

<3> A method of reacting a trialkylaluminium with water having been infiltrated into silica gel, etc.

<4> A method of directly reacting a mixture of trimethylaluminium and triisobutylaluminium with water in an organic solvent such as toluene, ether, etc.

<5> A method of reacting a mixture of trimethylaluminium and triisobutylaluminium with a salt containing crystal water, such as copper sulfate hydrate, aluminium sulfate hydrate, etc.

<6> A method of reacting water having been infiltrated into silica gel or the like with triisobutylaluminium and then with trimethylaluminium.

The compounds capable of reacting with the above-mentioned metallocene compound (A) to form ion pairs include Lewis acids, ionic compounds, borane compounds and carborane compounds such as those described in International Patent Publication Nos. 501950/1989, 502036/1989, Japanese Patent Laid-Open Nos. 179005/1991, 179006/1991, 207704/1991, WO92/00333 etc.

The Lewis acids are those containing a boron atom. Their specific but non-limitative examples are trifluoroboron, triphenylboron, tris(4-fluorophenyl)boron, tris(3,5-fluorophenyl)boron, tris(4-fluoromethylphenyl)boron, tris(p-tolyl)boron, tris(o-tolyl)boron, tris(3,5-dimethylphenyl)boron, tris(pentafluorophenyl)boron, etc. Of those, especially preferred is tris(pentafluorophenyl)boron.

The ionic compounds are salts composed of a cationic compound and an anionic compound. In these, the anion reacts with the metallocene compound to cationize it, thereby forming an ion pair to stabilize the transition metal cation constituting the compound. The anion of the type includes organoboron compound anions, organoarsenic compound anions, organoaluminium compound anions, etc. Preferred for use herein are those that are relatively bulky and can stabilize transition metal cations. The cation includes metal cations, organometal cations, carbonium cations, trityl cations, oxonium cations, sulfonium cations, phosphonium cations, ammonium cations, etc. More precisely, it includes triphenylcarbenium cations, tributylammonium cations, N,N-dimethylammonium cations, ferrocenium cations, etc.

Of those, preferred are ionic compounds containing a cation of a boron compound. Concretely mentioned are trialkyl-substituted ammonium salts such as triethylammonium tetra (phenyl)borate, tripropylammonium tetra (phenyl)borate, tri(n-butyl)ammonium tetra(phenyl)borate, trimethylammonium tetra(p-tolyl)borate, trimethylammoniumtetra(o-tolyl)borate, tributylammonium tetra(pentafluorophenyl)borate, tripropylammonium tetra(o,p-dimethylphenyl)borate, tributylammonium tetra(m,m-dimethylphenyl)borate, tributylammonium tetra(p-trifluoromethylphenyl)borate, tri(n-butyl)ammonium tetra(o-tolyl)borate, tri(n-butyl)ammonium tetra(4-fluourophenyl)borate, etc.

Also mentioned are N,N-dialkylanilinium salts such as N,N-dimethylanilinium tetra(phenyl)borate, N,N-diethylanilinium tetra(phenyl)borate etc.; dialkylammonium salts such as di(n-propyl)ammonium tetra(pentafluorophenyl)borate, dicyclohexylammonium tetra(pentafluorophenyl)borate, etc.; triarylphosphonium salts such as, tri(methylphenyl)phosphonium tetra(phenyl)borate, tri(dimethylphenyl)phosphonium tetra(phenyl)borate, etc.

For the boron atom-containing ionic compounds for use in the invention, further mentioned are triphenylcarbenium tetrakis(pentafluorophenyl)borate, N,N-dimethylanilinium tetrakis(pentafluorophenyl)borate, ferrocenium tetra(pentafluorophenyl)borate, etc.

The metallocene catalyst system (A) to be used in producing the elastomeric polypropylene for use in the invention optionally contains an organoaluminium compound. The organoaluminium compound is represented by the following general formula (6):

AlR⁴ₛR⁵ₜX₍₃₋ₛ₋ₜ₎ (6).

In formula (6), R⁴ and R⁵ each independently represent a hydrocarbon group, such as an alkyl group having from 1 to 10 carbon atoms, a cycloalkyl group, an aryl group or the like, or a phenyl group optionally substituted by-substituent(s) selected from an alkoxy group, a fluorine atom, a methyl group, a trifluoromethyl group, etc.; X represents a halogen atom and/or hydrogen atom; and s and t each are an integer, satisfying 0<s+t≦3.

Organoaluminium compounds of formula (6) include, for example, trialkylaluminiums such as trimethylaluminium, triethylaluminium, triisopropylaluminium, triisobutylaluminium, tri-n-butylaluminium, tri-n-hexylaluminium, tri-n-octylaluminium, etc.; dialkylaluminium hydrides such as dimethylaluminium hydride, diethylaluminium hydride, diisopropylaluminium hydride, diisobutylaluminium hydride, etc.; dialkylaluminium halides such as dimethylaluminium chloride, dimethylaluminium bromide, diethylaluminium chloride, diisopropylaluminium chloride, etc.; alkylaluminium sesquihalides such as methylaluminium sesquichloride, ethylaluminium sesquichloride, ethylaluminium sesquibromide, isopropylaluminium sesquichloride, etc. Two or more of these compounds may be used, as combined.

For the organoaluminium compound for use herein, preferred are trialkylaluminiums such as triethylaluminium, triisobutylaluminium, tri-n-butylaluminium, tri-n-hexylaluminium, tri-n-octylaluminium, etc.; and most preferred are triethylaluminium and triisobutylaluminium.

One modification of the metallocene catalyst (A) to be used in producing the elastomeric polypropylene for use in the invention is a supported metallocene catalyst (A) supported on a particulate carrier. For this, the particulate carrier may be any of organic particulate carriers and inorganic particulate carriers, but preferred are inorganic particulate carriers. The inorganic particulate carriers are granular or spherical, inorganic solid particles having a particle size of from 5 to 300 μm, preferably from 10 to 200 μm. Preferably, they are porous particles having a specific surface area of from 50 to 1,000 m²/g, more preferably from 100 to 700 m²/g, and having a pore volume of from 0.3 to 2.5 m³/g.

For the inorganic particulate carriers, preferred are metal oxides, such as SiO₂, Al₂O₃, MgO, TiO₂, ZnO, or their mixtures; and more preferred are those comprising, as the essential ingredient, SiO₂ or Al₂O₃. More specific examples of the inorganic compounds are SiO₂, Al₂O₃, MgO, SiO₂—Al₂O₃, SiO₂—MgO, SiO₂—TiO₂, SiO₂—Al₂O₃—MgO, etc. Especially preferred is SiO₂.

In case where the above-mentioned supported metallocene catalyst (A) is used as the metallocene catalyst system (A) in producing the elastomeric polypropylene for use in the invention, the supported metallocene catalyst (A) forms a mixed catalyst system along with an organoaluminium compound that shall be introduced into the polymerization system separately from it. For this, the organoaluminium compound may be one represented by the above-mentioned formula (6).

Another preferred type of the catalyst to be used in producing the elastomeric polypropylene for use in the invention is, apart from the above-mentioned metallocene catalyst system (A), a carrier of tetraneophyl zirconium of the following chemical formula (7) supported on alumina. In case where the catalyst of the type is used in (co) polymerization of propylene or propylene and olefin except propylene, it forms a mixed catalyst system along with an organoaluminium compound that shall be introduced into the (co)polymerization system separately from it. For this, the organoaluminium compound may also be one represented by the above-mentioned formula (6).

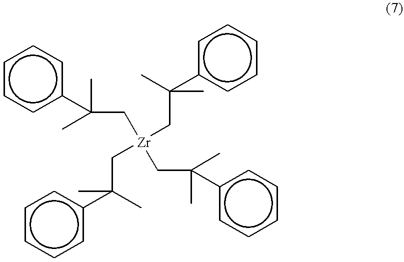

The catalyst of tetraneophyl zirconium supported on alumina may be prepared in any known method, such as those described in U.S. Pat. No. 5,629,255, Japanese Patent Laid-Open Nos. 145274/1995, 145296/1995, U.S. Pat. No. 4,411,821, Japanese Patent Laid-Open No. 61006/1982, U.S. Pat. Nos. 4,228,263, 4,335,225, Japanese Patent Laid-Open Nos. 161583/1975, 161584/1975, etc.

Precisely, for example, the supported catalyst of tetraneophyl zirconium/alumina may be prepared according to the process mentioned below, of which all the steps are effected in a nitrogen gas atmosphere.

First, commercially-available alumina C is dewatered in a nitrogen stream atmosphere at 800 to 1000° C., then stored at 23° C. at 50% RH for 16 hours, and thereafter further dried in a nitrogen stream atmosphere at 400° C., thereby having an optimum surface hydroxyl concentration of about 1 mmol/g (alumina C). 266.7 g of the thus-processed alumina is weighed and put into a 6-liter four-neck flask having been fully purged with nitrogen gas, to which is added 5035 ml of n-hexane having been purified with BASF's Cu catalyst (R3-11) and Molecular Sieve 4A. The resulting suspension is stirred at 300 rpm for about 1 hour.

Next, 33.23 g of tetraneophyl zirconium is dissolved in 465 ml of n-hexane (this is previously purified in the same manner as above) at 20° C., and the resulting tetraneophyl zirconium solution is as soon as possible and dropwise added to the alumina suspension over a period of 50 minutes with continuously stirring it. After the tetraneophyl zirconium solution has been thus added thereto, the resulting mixture is still continuously stirred for 12.5 hours at a lowered revolution speed of about 120 rpm, while being shielded from light. The resulting solid catalyst is kept as such for 1 hour (this is for promoting the filtration in the next step), and the suspension containing it is finally filtered under pressure through glass frit to separate the catalyst (time for filtration: 3 hours). Next, the solid catalyst is dried with stirring under a reduced pressure lower than 1 Pa, until it has a constant weight of 292 g (time for drying: about 5 hours). All these steps are effected in an extremely pure nitrogen atmosphere. The thus-obtained tetraneophyl zirconium/alumina catalyst is beige to light brown, and generally forms small spheres having a diameter of about 1 mm. Its Zr content is 1.66% by weight.

In place of tetraneophyl zirconium mentioned above, also usable herein are supported catalysts of bis (arene) compounds such as bis(toluene)titanium, bis(toluene)zirconium, bis(toluene)hafnium, bis(mesitylene)titanium and the like supported on alumina. Methods for producing the catalysts are described in Macromol. Chem., Rapid Commun. 10, 19-23 (1989); J. Polym. Sci., Part A: Polym. Chem., 27, 3063-3081 (1989).

Optionally combined with vanadium catalysts such as those described in DD 300293-A7 and Plaste und Kautschuk, 38, Jahrgang, Heft 3, pp. 73-77 (1991), etc., the above-mentioned metallocene catalyst system (A) and alumina-supported tetraneophyl zirconium may be used in producing the elastomeric polypropylene for use in the invention.

Any known olefin polymerization process is applicable to producing the elastomeric polypropylene for use in the invention. It includes, for example, a slurry polymerization method of (co)polymerizing olefins in an inert solvent of, for example, aliphatic hydrocarbons such as such butane, pentane, hexane, heptane, isooctane, etc., alicyclic hydrocarbons such as cyclopentane, cyclohexane, methylcyclohexane, etc., aromatic hydrocarbons such as toluene, xylene, ethylbenzene, etc., gasoline fractions, hydrogenated diesel oil fractions, etc.; a bulk polymerization method of (co)polymerizing olefins in which the olefin itself serves as a solvent; a vapor-phase polymerization of (co)polymerizing olefins in a vapor phase; and a combination of two or more of these methods.

For the condition for (co)polymerization in the above-mentioned methods, generally referred to are the same as those for (co)polymerization of olefins in the presence of known Ziegler-Natta catalysts. In these methods, for example, propylene and optionally other α-olefins are (co)polymerized generally in the presence of hydrogen serving as a molecular weight-controlling agent, at a temperature falling between −50 and 150° C., preferably between −10 and 100° C., more preferably between 45° C. and 90° C., and under a pressure falling between atmospheric pressure and 7 MPa, preferably between 0.2 and 5 MPa, for a period of from 1 minute to 20 hours or so.

After having been thus (co)polymerized, the reaction mixture is optionally subjected to known post-treatment for catalyst deactivation, catalyst residue removal, drying, etc., to obtain the intended elastomeric polypropylene. The thus-obtained elastomeric polypropylene may be directly used in producing the polypropylene composition of the invention.

The elastomeric polypropylene obtained in the manner as above may be directly used in producing the polypropylene composition of the invention. If desired, however, various additives such as antioxidant, UV absorbent, antistatic agent, nucleating agent, lubricant, flame retardant, anti-blocking agent, colorant, organic filler, inorganic filler, etc., and also other various synthetic resins may be added to it. In general, it is desirable that the polymer optionally mixed with such additives and resins is heated, melted and kneaded in a melt kneader generally at a temperature falling between 190° C. and 350° C. for a period of from 20 seconds to 30 minutes or so, then optionally extruded into strands, and pelletized into pellets, and the resulting polymer pellets are used in producing the polypropylene composition of the invention.

The atactic polypropylene for use in the invention may be any and every one produced in the presence of a metallocene catalyst, including, for example, APAO of Ube Industries Ltd., Huntsman's Rexflex FPO, etc.

For its molecular weight, the atactic polypropylene for use in the invention preferably has a limiting viscosity [η] of from 1 to 7 dl/g, more preferably from 1 to 4 dl/g. So far as it has an atactic structure, the atactic polypropylene may be any of propylene homopolymers and propylene/α-olefin copolymers in which the α-olefin includes ethylene, 1-butene, 1-hexene, 1-octene and the like. The α-olefin content of the copolymers shall be at most 50% by weight.

The catalyst to be used in producing the atactic polypropylene for use in the invention is not specifically defined, so far as it is effective for producing the intended polypropylene having an atactic structure. For this, however, preferred is a metallocene catalyst system to be mentioned below. Specifically, the metallocene catalyst system (B) for the atactic polypropylene includes a metallocene catalyst (B) that comprises a metallocene compound (B), an activator compound and optionally an organoaluminium compound, and a supported metallocene catalyst (B) that comprises the metallocene catalyst (B) supported on a particulate carrier.

The metallocene catalyst (B) is not specifically defined so far as it is for producing atactic polypropylene. For its specific examples, mentioned are known metallocene compounds for producing atactic polypropylene, such as those of the following general formula (8):

(C₅H₅₋ₘRₘ) (C₅H₅₋ₙRₙ) MX₂ (8).

In formula (8), Rₘ and Rₙ may be the same or different, and each represents a hydrogen atom, a hydrocarbon group having from 1 to 20 carbon atoms, a silicon-containing hydrocarbon group, or a hetero-aromatic ring optionally substituted with a hydrocarbon group; two R's may be bonded to each other to form a hydrocarbon ring optionally substituted with at least one hydrocarbon group; m and n each fall between 1 and 4; M represents a transition metal selected from titanium, zirconium and hafnium; X represents a hydrogen atom, a halogen atom, or a hydrocarbon group having from 1 to 20 carbon atoms.

Specific but non-limitative examples of the metallocene compound (B) of formula (8) are bis(cyclopentadienyl)zirconium dichloride, bis(methylcyclopentadienyl)zirconium dichloride, bis(1,2-dimethylcyclopentadienyl)zirconium dichloride, bis(1,3-dimethylcyclopentadienyl)zirconium dichloride, bis(1,2,3-trimethylcyclopentadienyl)zirconium dichloride, bis(1,2,4-trimethylcyclopentadienyl)zirconium dichloride, bis (tetramethylcyclopentadienyl)zirconium dichloride, bis (indenyl) zirconium dichloride, bis (methylindenyl) zirconium dichloride, bis (fluorenyl) zirconium dichloride, bis (1,2-dimethyl-4-phenylcyclopentadienyl) zirconium dichloride, bis(1-(2-furyl)-3,4-dimethyl) zirconium dichloride, bis(1-(2-thienyl)-3,4-dimethyl)zirconium dichloride, etc. The metal zirconium in these compounds may be substituted with titanium or hafnium, and such titanium or hafnium compounds are within the scope of the metallocene compound (B) of formula (8).

Further mentioned for use herein are metallocene compounds of the following general formula (9):

(C₅H₅₋ₘRₘ)MX₃ (9).

In formula (9), Rₘ is meant to indicate a hydrogen atom, a hydrocarbon group having from 1 to 20 carbon atoms, a silicon-containing hydrocarbon group, or a hetero-aromatic ring; two R's may be bonded to each other to form a hydrocarbon ring optionally substituted with at least one hydrocarbon group; m fall between 1 and 4; M represents a transition metal selected from titanium, zirconium and hafnium; X represents a hydrogen atom, a halogen atom, or a hydrocarbon group having from 1 to 20 carbon atoms.

Specific but non-limitative examples of the metallocene compound (B) of formula (9) are (cyclopentadienyl)zirconium trichloride, (methylcyclopentadienyl) zirconium trichloride, (1,2-dimethylcyclopentadienyl)zirconium trichloride, (1,3-dimethylcyclopentadienyl)zirconium trichloride, (1,2,3-trimethylcyclopentadienyl)zirconium trichloride, (1,2,4-trimethylcyclopentadienyl)zirconium trichloride, (tetramethylcyclopentadienyl)zirconium trichloride, (indenyl) zirconium trichloride, (methylindenyl) zirconium trichloride, (fluorenyl)zirconium trichloride, (1,2-dimethyl-4-phenylcyclopentadienyl)zirconium trichloride, (1-(2-furyl)-3,4-dimethyl)zirconium trichloride, (1-(2-thienyl)-3,4-dimethyl) zirconium trichloride, etc. The metal zirconium in these compounds may be substituted with titanium or hafnium, and such titanium or hafnium compounds are within the scope of the metallocene compound (B) of formula (9).

Still further mentioned for use herein are metallocene compounds of the following general formula (10):

Q(C₅H₄₋ₘR¹ₘ) (C₅H₄₋ₙR²ₙ)MXY (10).

In formula (10), (C₅H₄₋ₘR¹ₘ) and (C₅H₄₋ₙR²ₙ) each represent a substituted cyclopentadienyl group; m and n each are an integer of from 1 to 3; R¹ and R² each represent a hydrocarbon group having from 1 to 20 carbon atoms, a silicon-containing hydrocarbon group, or a hydrocarbon group that bonds to two carbon atoms on the cyclopentadienyl ring to form at least one hydrocarbon ring optionally substituted with a hydrocarbon group, and these may be the same or different; but for their type and position on the cyclopentadienyl ring, R¹ and R² shall be so positioned that they form a symmetric face which contains M, and, in at least one cyclopentadienyl ring, R¹ or R² shall be bonded to at least one carbon atom that neighbors to the carbon atom bonded to Q; Q represents a divalent hydrocarbon, non-substituted silylene, hydrocarbon-substituted silylene group, non-substituted germylene group or hydrocarbon-substituted germylene group that crosslinks (C₅H₄₋ₘR¹ₘ) and (C₅H₄₋ₙR²ₙ); M represents a transition metal of titanium, zirconium or hafnium; X and Y may be the same or different, and each represents a hydrogen atom, a halogen atom, or a hydrocarbon group.

Specific but non-limitative examples of the compounds of formula (10) are ethylenebis(indenyl)zirconium-dimethyl, ethylenebis(indenyl)zirconium dichloride, dimethylsilylenebis(indenyl)zirconium-dimethyl, dimethylsilylenebis(indenyl)zirconium dichloride, ethylenebis(tetrahydroindenyl)zirconium-dimethyl, dimethylgermylbis(indenyl)zirconium-dimethyl, dimethylgermylbis(indenyl)zirconium dichloride, ethylenebis(tetrahydroindenyl)zirconium-dimethyl, ethylenebis(tetrahydroindenyl)zirconium dichloride, dimethylsilylenebis(tetrahydroindenyl)zirconium-dimethyl, dimethylsilylenebis (tetrahydroindenyl) zirconium dichloride, dimethylgermylbis(tetrahydroindenyl)zirconium-dimethyl, dimethylgermylbis(tetrahydroindenyl)zirconium dichloride, dimethylsilylenebis(2-methyl-4,5,6,7-tetrahydroindenyl)zirconium dichloride, dimethylsilylenebis(2-methyl-4,5,6,7-tetrahydroindenyl) zirconium-dimethyl, dimethylgermylbis (2-methyl-4,5,6,7-tetrahydroindenyl)zirconium dichloride, dimethylgermylbis(2-methyl-4,5,6,7-tetrahydroindenyl)zirconium-dimethyl, ethylenebis(2-methyl-4,5,6,7-tetrahydroindenyl)hafnium dichloride, dimethylsilylenebis(2-methyl-4-phenylindenyl)zirconium dichloride, dimethylsilylenebis(2-methyl-4-phenylindenyl)zirconium-dimethyl, dimethylgermylbis(2-methyl-4-phenylindenyl)zirconium dichloride, dimethylgermylbis(2-methyl-4-phenylindenyl)zirconium-dimethyl, dimethylsilylenebis(2-methyl-4-phenylindenyl)hafnium dichloride, dimethylsilylenebis(2-methyl-4-naphthylindenyl)zirconium-dimethyl, dimethylsilylenebis(2-methyl-4-naphthylindenyl)hafnium dichloride, dimethylgermylbis(2-methyl-4-naphthylindenyl)zirconium-dimethyl, dimethylgermylbis(2-methyl-4-naphthylindenyl)hafnium dichloride, dimethylsilylenebis(2-methyl-4,5-benzoindenyl) zirconium dichloride, dimethylsilylenebis (2-methyl-4,5-benzoindenyl)zirconium-dimethyl, dimethylgermylbis(2-methyl-4,5-benzoindenyl)zirconium dichloride, dimethylgermylbis(2-methyl-4,5-benzoindenyl)zirconium-dimethyl, dimethylsilylenebis(2-methyl-4,5-benzoindenyl)hafnium dichloride, dimethylsilylenebis(2-ethyl-4-phenylindenyl)zirconium dichloride, dimethylsilylenebis(2-ethyl-4-phenylindenyl)zirconium-dimethyl, dimethylgermylbis(2-ethyl-4-phenylindenyl)zirconium dichloride, dimethylsilylenebis(2-ethyl-4-phenylindenyl)hafnium dichloride, dimethylsilylenebis(2-methyl-4,6-diisopropylindenyl)zirconium dichloride, dimethylsilylenebis(2-methyl-4,6-diisopropylindenyl)zirconium-dimethyl, dimethylgermylbis(2-methyl-4,6-diisopropylindenyl)zirconium dichloride, dimethylsilylenebis(2-methyl-4,6-diisopropylindenyl)hafnium dichloride, dimethylsilylenebis(2,4-dimethylcyclopentadienyl)titanium dichloride, dimethylsilylenebis(2,4-dimethylcyclopentadienyl)zirconium dichloride, dimethylsilylenebis(2,4-dimethylcyclopentadienyl)zirconium-dimethyl, dimethylgermylbis(2,4-dimethylcyclopentadienyl)zirconium dichloride, dimethylgermylbis(2,4-dimethylcyclopentadienyl)zirconium-dimethyl, dimethylsilylenebis(2,4-dimethylcyclopentadienyl)hafnium dichloride, dimethylsilylenebis(2,4-dimethylcyclopentadienyl)hafnium-dimethyl, dimethylsilylenebis(2,3,5-trimethylcyclopentadienyl)titanium dichloride, dimethylsilylenebis(2,3,5-trimethylcyclopentadienyl)zirconium dichloride, dimethylsilylenebis(2,3,5-trimethylcyclopentadienyl)zirconium-dimethyl, dimethylgermylbis(2,3,5-trimethylcyclopentadienyl)zirconium dichloride, dimethylgermylbis(2,3,5-trimethylcyclopentadienyl)zirconium-dimethyl, dimethylsilylenebis(2,3,5-trimethylcyclopentadienyl)hafnium dichloride, dimethylsilylenebis(2,3,5-trimethylcyclopentadienyl)hafnium-dimethyl, dimethylsilylenebis(2-methyl-4-phenyldihydroazurenyl)zirconium dichloride, dimethylsilylenebis(2-ethyl-4-phenyldihydroazurenyl)zirconium dichloride.

Of the metallocene compounds (B) mentioned above, especially preferred are dimethylsilylenebis(2-methyl-4-phenylindenyl)zirconium dichloride, dimethylgermylbis(2-methyl-4-phenylindenyl)zirconium dichloride, dimethylgermylbis(2-methyl-4-phenylindenyl)zirconium dichloride, dimethylsilylenebis(2-methyl-4-naphthylindenyl)zirconium dichloride, dimethylgermylbis(2-methyl-4-naphthylindenyl)zirconium dichloride, dimethylsilylenebis(2-methyl-4,5-benzoindenyl)zirconium dichloride, dimethylgermylbis(2-methyl-4,5-benzoindenyl) zirconium dichloride, dimethylsilylenebis (2-ethyl-4-phenylindenyl)zirconium dichloride, dimethylgermylbis(2-ethyl-4-phenylindenyl)zirconium dichloride, dimethylsilylenebis(2-methyl-4,6-diisopropylindenyl)zirconium dichloride, dimethylgermylbis(2-methyl-4,6-diisopropylindenyl)zirconium dichloride, dimethylsilylenebis(2,4-dimethylcyclopentadienyl)zirconium dichloride, dimethylsilylenebis(2,4-dimethylcyclopentadienyl)zirconium-dimethyl, dimethylgermylbis(2,4-dimethylcyclopentadienyl)zirconium dichloride, dimethylgermylbis(2,4-dimethylcyclopentadienyl)zirconium-dimethyl, dimethylsilylenebis(2,4-dimethylcyclopentadienyl)hafnium dichloride, dimethylsilylenebis(2,4-dimethylcyclopentadienyl)hafnium-dimethyl, dimethylsilylenebis (2,3,5-trimethylcyclopentadienyl)zirconium dichloride, dimethylsilylenebis(2,3,5-trimethylcyclopentadienyl) zirconium-dimethyl, dimethylgermylbis(2,3,5-trimethylcyclopentadienyl)zirconium dichloride, dimethylgermylbis (2,3,5-trimethylcyclopentadienyl) zirconium-dimethyl, dimethylsilylenebis(2,3,5-trimethylcyclopentadienyl) hafnium dichloride, dimethylsilylenebis (2,3,5-trimethylcyclopentadienyl) hafnium-dimethyl, dimethylsilylenebis(2-methyl-4-phenyldihydroazurenyl) zirconium dichloride.

Still further mentioned for use herein are metallocene compounds of the following general formula (11)

CpZ¹Y²M²X³_{w} (11).

In formula (11), M² represents a transition metal atom of Group IVB, concretely including titanium, zirconium and hafnium atoms; Cp represents a cyclic unsaturated hydrocarbon group or a linear unsaturated hydrocarbon group, such as a cyclopentadienyl group, a substituted cyclopentadienyl group, an indenyl group, a substituted indenyl group, a tetrahydroindenyl group, a substituted tetrahydroindenyl group, a fluorenyl group, a substituted fluorenyl group or the like.

X³ represents a hydrogen atom, a halogen atom, an alkyl, an alkylaryl or arylalkyl group having from 1 to 20 carbon atoms, or an alkoxy group having from 1 to 20 carbon atoms. Z¹ represents SiR⁷₂, CR⁷₂, SiR⁷₂SiR⁷₂, CR⁷₂CR⁷₂, CR⁷₂CR⁷₂CR⁷₂, CR⁷═CR⁷, CR⁷₂SiR⁷₂ or GeR⁷₂. Y² represents —N(R⁸)—, —O—, —S— or —P(R⁸)—.

R⁷ and R⁸ may be independently the same or different, each representing a hydrogen atom, or an alkyl, alkylaryl or arylalkyl group having from 1 to 20 carbon atoms; and w indicates 1 or 2.

Specific but non-limitative examples of the metallocene compound (B) of formula (11) are (t-butylamido)(tetramethylcyclopentadienyl)-1,2-ethanediylzirconium dichloride, (t-butylamido)(tetramethylcyclopentadienyl)-1,2-ethanediyltitanium dichloride, (methylamido)(tetramethylcyclopentadienyl)-1,2-ethanediylzirconium dichloride, (methylamido)(tetramethylcyclopentadienyl)-1,2-ethanediyltitanium dichloride, (ethylamido)(tetramethylcyclopentadienyl)methylenetitanium dichloride, (t-butylamido)dimethyl(tetramethylcyclopentadienyl)silanetitanium dichloride, (t-butylamido)dimethyl(tetramethylcyclopentadienyl)silanezirconium dichloride, (benzylamido)dimethyl(tetramethylcyclopentadienyl)silanetitanium dichloride, (phenylphosphido)dimethyl(tetramethylcyclopentadienyl)silanezirconium-dibenzyl, etc.

For the details of the activator compound and the optional organoaluminium compound to constitute the metallocene catalyst (B) which is for producing the atactic polypropylene for use in the invention, referred to are the same as those mentioned hereinabove for the activator compound and the organoaluminium compound to constitute the metallocene catalyst (A) which is for producing the elastomeric polypropylene for use herein.

Apart from the metallocene catalyst (B) that comprises the metallocene compound (B), the activator compound and the optional organoaluminium compound, also usable herein for producing the atactic polypropylene is a carrier-held metallocene catalyst (B) that comprises the metallocene catalyst (B) supported on a particulate carrier. For the details of the particulate carrier for the supported metallocene catalyst (B), also referred to are the same as those mentioned hereinabove for the supported metallocene catalyst (A) which is for producing the elastomeric polypropylene.

In case where the supported metallocene catalyst (B) is used for producing the atactic polypropylene for use in the invention, it forms a mixed catalyst system along with an organoaluminium compound that shall be introduced into the polymerization system separately from it. For this, the organoaluminium compound may be one represented by the above-mentioned formula (6).

For producing the atactic polypropylene for use in the invention, employable are the same (co)polymerization methods as those for the elastomeric polypropylene mentioned hereinabove. For it, briefly, employable is any of a slurry (co)polymerization method of polymerizing olefins in an inert solvent; a bulk (co)polymerization method of polymerizing olefins in which the olefin itself serves as a solvent; a vapor-phase (co)polymerization of polymerizing olefins in a vapor phase; and a combination of two or more of these methods. For the details of the (co)polymerization condition, referred to are the same as those mentioned hereinabove for (co)polymerization to give the elastomeric polypropylene. After having been thus polymerized, the reaction mixture is optionally subjected to known post-treatment for catalyst deactivation, catalyst residue removal, drying, etc., to obtain the intended atactic polypropylene.

The elastomeric polypropylene obtained in the manner as above may be directly used in producing the polypropylene composition of the invention. If desired, however, various additives such as antioxidant, UV absorbent, antistatic agent, nucleating agent, lubricant, flame retardant, anti-blocking agent, colorant, inorganic or organic filler, etc., and also other various synthetic resins may be added to it. In general, it is desirable that the polymer optionally mixed with such additives and resins is heated, melted and kneaded in a melt kneader generally at a temperature falling between 190° C. and 350° C. for a period of from 20 seconds to 30 minutes or so, then optionally extruded into strands, and pelletized into pellets, and the resulting polymer pellets are used in producing the polypropylene composition of the invention.

For producing the polypropylene composition of the invention, or that is, for blending the elastomeric polypropylene and the atactic polypropylene, preferred is any of the following methods:

(1) A method of blending the elastomeric polypropylene and the atactic polypropylene in dry;

(2) A method of melting and kneading the elastomeric polypropylene and the atactic polypropylene in an extruder, a kneader or the like.

The polypropylene composition of the invention has the advantages of good flexibility and good elastic recovery, and is therefore favorable to molding materials for various moldings such as films, sheets, blow moldings, injection moldings, etc.

The polypropylene composition of the invention is a molding material having the advantages of good flexibility and good elastic recovery. It is favorable to the field of various moldings that are required to have good flexibility and good elastic recovery.

### EXAMPLES

The invention is described in more detail with reference to the following Examples and Comparative Examples.

The meanings of the terms used in Examples and Comparative Examples as well as the methods employed therein for measuring the physical properties of the polymers and the polymer compositions produced are mentioned below.

(1) Melt Flow Rate (MFR):

This is measured according to JIS K7210, under the condition 14 in Table 1 (under a load of 21.18 N and at 230° C.) and its unit is g/10 min.

(2) Intrinsic Viscosity [η]:

This is measured by the use of an automatic viscometer (Mitsui Toatsu's AVS2 Model), in a solvent of tetralin at 135° C., and its unit is dl/g.

(3) Durometer Hardness:

This is measured according to JIS K7215, for which is used a type A durometer.

(4) Permanent Set:

This is measured according to JIS K6301. Briefly, a sample to be tested is elongated by 100% by the use of a JIS #1 dumbbell, kept as it is for 10 minutes, and then relaxed. After kept relaxed for 10 minutes, the length of the sample is measured. Samples having a smaller Permanent Set have better elastic recovery.

### Production Example 1

Production of Elastomeric Polypropylene (ELPP-1)

3.2×10⁻³ mols, in terms of Al, of an aluminoxane, Tosoh-Akuzo's MMAO, and 800 ml of liquefied propylene monomer were put into a 1.5 liter autoclave that had been fully purged with nitrogen, and stirred for 5 minutes at 30° C.. On the other hand, 9.8×10⁻⁶ mols, in terms of Zr, of a metallocene compound (A) , bis[2-(2-furyl)indenyl]zirconium dichloride, and 1.7×10⁻³ mols, in terms of Al, of MMAO were mixed for 15 minutes to prepare a metallocene catalyst (A). The metallocene catalyst (A) was introduced under pressure into the autoclave along with 200 ml of liquefied propylene, in the presence of which the monomer in the autoclave began to polymerize at 30° C. The polymerization was continued for 2 hours at 30° C. under constant pressure. After 2 hours, 20 ml of methanol was introduced by nitrogen pressure into the autoclave to stop the polymerization.

Next, the propylene monomer was purged away, and 1000 ml of toluene was led into the autoclave, and stirred at 50° C. for 90 minutes. Next, 50 ml of methanol, 5 g of sodium hydroxide, and 250 ml of pure water were added to the reaction mixture, stirred at 70° C. for 90 minutes, and then cooled. The aqueous phase was removed through a separating funnel, and the remaining toluene phase was washed with pure water until the wash water became neutral. A large quantity of methanol was added to the thus-washed toluene phase, and the polymer thus having precipitated was taken out. This was dried in a vacuum drier until its weight became constant. Thus was obtained 58 g of elastomeric polypropylene.

100 parts by weight of the thus-obtained elastomeric polypropylene was mixed with 0.1 parts by weight of 2,6-di-t-butyl-p-cresol, and kneaded in a mixer, Toyo Seiki's Laboplastomill Model 30C150, at200° C. for 5 minutes. With that, the polymer was analyzed. Its MFR was 1.6 g/10 min, and its intrinsic viscosity [η] was 2.1 dl/g.

### Production Example 2

Production of Atactic Polypropylene (APP-1)

1200 ml of toluene, and 0.02 mols, in terms of Al, of an aluminoxane, Tosoh-Akuzo's MMAO were put into a 3 liter reactor that had been fully purged with nitrogen. To this was added 2×10⁻⁶ mols, in terms of Ti, of a metallocene compound (B), (t-butylamido)dimethyl(tetramethylcyclopentadienyl) silane-titanium dichloride, and stirred for 5 minutes to prepare a metallocene catalyst (B). Then, with the reactor being heated to have an inner temperature of 70° C., propylene monomer was led thereinto, and polymerized for 2 hours under a constant inner pressure of 0.7 MPaG. After that, 50 ml of a polymerization terminator, methanol was introduced under pressure into the reactor along with high-pressure nitrogen to stop the polymerization. Next, the propylene monomer remaining in the reactor was purged away, and then 5 g of sodium hydroxide and 250 ml of water were led into the reactor and stirred at 70° C. for 1 hour. With that, the reactor was cooled to room temperature, and the aqueous phase was removed from it. Next, 300 ml of pure water was led into the reactor and stirred for 10 minutes at room temperature for 10 minutes, and thereafter the aqueous phase was removed. This process was repeated twice. Next, the remaining toluene phase was led into a large quantity of methanol to thereby make the polymer precipitate in methanol. The polymer was dried in a vacuum drier at 80° C. until its weight became constant. Thus was obtained 54 g of polypropylene. This was analyzed, and its [η] was 6.94 dl/g. This was identified as atactic polypropylene by its ¹³C-NMR.

### Example 1

Production and Evaluation of Polypropylene Composition

ELPP-1 produced in Production Example 1 and APP-1 produced in Production Example 2 were mixed in a ratio of 50/50% by weight. 100 parts by weight of the resulting polymer mixture, and 0.1 parts by weight of 2,6-di-t-butyl-p-cresol added thereto were kneaded in a mixer, Toyo Seiki's Laboplastomill Model 30C150, at 200° C. for 5 minutes, and then formed into a press sheet having a thickness of 1 mm, at the melting temperature of 200° C. The physical properties of the sheet were measured. The MFR of the polymer melt was 0.7 g/10 min; the durometer hardness HAD of the sheet was 64, measured according to JIS K7215 with a type A durometer; and the Permanent Set of the sheet was 10%.

### Example 2

Production and Evaluation of Polypropylene Composition

ELPP-1 produced in Production Example 1 and APP-1 produced in Production Example 2 were mixed in a ratio of 30/70% by weight. 100 parts by weight of the resulting polymer mixture, and 0.1 parts by weight of 2,6-di-t-butyl-p-cresol added thereto were kneaded in a mixer, Toyo Seiki's Laboplastomill Model 30C150, at 200° C. for 5 minutes, and then formed into a press sheet having a thickness of 1 mm, at the melting temperature of 200° C. The physical properties of the sheet were measured. The MFR of the polymer melt was 0.4 g/10 min; the durometer hardness HAD of the sheet was 58, measured according to JIS K7215 with a type A durometer; and the Permanent Set of the sheet was 8%.

### Comparative Example 1

ELPP-1 produced in Production Example 1 was formed into a press sheet having a thickness of 1 mm, at a melting temperature 200° C. The physical properties of the sheet were measured. The MFR of the polymer melt was 1.6 g/10 min; the durometer hardness HDA of the sheet was 80, measured according to JIS K7215 with a type A durometer; and the Permanent Set of the sheet was 14%.

### Comparative Example 2

Huntsman's high-flexibility polypropylene, Rexflex FPO, Grade WL118 (this is propylene homopolymer) was formed into a press sheet having a thickness of 1 mm, at a melting temperature 200° C. The physical properties of the sheet were measured. The MFR of the polymer melt was 26.7 g/10 min; the durometer hardness HAD of the sheet was 92, measured according to JIS K7215 with a type A durometer; and the Permanent Set of the sheet was 23%.

What is claimed is:

1. A polypropylene composition comprising from 1 to 99% by weight of elastomeric polypropylene obtained through (co)polymerization of propylene or propylene and olefin except propylene in the presence of a metallocene catalyst (A) that comprises a metallocene compound (A), an activator compound and optionally an organoaluminium compound, or of a supported metallocene catalyst (A) that comprises the metallocene catalyst (A) supported on a particulate carrier, or of a catalyst that comprises tetraneophyl zirconium supported on alumina, and from 1 to 99% by weight of atactic polypropylene totaling 100% by weight.

2. The polypropylene composition as claimed in claim 1, wherein the atactic polypropylene is obtained through (co) polymerization of propylene or propylene and olefin except propylene in the presence of a metallocene catalyst (B) that comprises a metallocene compound (B), an activator compound and optionally an organoaluminium compound, or of a supported metallocene catalyst (B) that comprises the metallocene catalyst (B) supported on a particulate carrier.

3. The polypropylene composition as claimed in claim 1, which has a durometer hardness, HDA of from 40 to 60, measured with a type A durometer according to JIS K7215.
